(19) United States
(12) Patent Application Publication
(10) Pub. No.: US 2014/0207377 A1
(43) Pub. Date: Jul. 24, 2014

(54) LANE DETERMINATION BASED ON SPATIAL DATA FROM LOCAL SOURCES

(71) Applicant: INTERNATIONAL BUSINESS MACHINES CORPORATION, Armonk, NY (US)

(72) Inventors: Manvendra Gupta, Brampton (CA); Stewart Jason Hyman, Richmond Hill (CA)

(73) Assignee: INTERNATIONAL BUSINESS MACHINES CORPORATION, Armonk, NY (US)

(21) Appl. No.: 13/744,944

(22) Filed: Jan. 18, 2013

(51) Int. Cl. G01C 21/34

(52) U.S. Cl. CPC G01C 21/3492
USPC 701/533

(57) ABSTRACT

A method, computer program product and system for determining an optimal lane recommendation of a road having a plurality of lanes for a primary vehicle within an optimal guided route to a destination. The steps including retrieving local environment data comprising real-time spatial data directly from at least one local source, the at least one local source comprising at least one sensor in an other vehicle; determining an optimal recommended lane of the road from the plurality of lanes of the road to minimize travel time for the primary vehicle, based on the directly retrieved environment data from the at least one source within a specific distance from the primary vehicle; and displaying the optimal recommended lane of the road for travel of the primary vehicle within the optimal guided route to the destination through an interface to a user.

### BACKGROUND

The present invention relates to lane determination for optimizing a route to a destination, and more specifically to lane determination within a local area based on spatial data received directly from local sources along an optimized route to a destination.

Electronic devices are capable of receiving, storing, and using large amounts of data, which are made available as batch updates corresponding to the latest and most reliable version of the data. A typical example is the data set of electronic maps and routes stored in global positioning system (GPS) navigation units used in automobiles.

Some GPS devices, for example differential GPS receivers (DGPS) provide improved location accuracy using a network of fixed, ground-based reference stations to broadcast the difference between the positions indicated by the satellite system and known fixed positions.

The lane-assist (or lane guidance) feature in some automotive GPS units, which recommends the possible lanes the vehicle must stay in, even while travelling on the freeway (or any other straight route with one or more exit routes) to ensure the driver does not deviate from the route inadvertently. However, this functionality doesn't work when a driver is driving on a route where one or more of the possible lanes on the route is obstructed by an accident or construction or because a car up ahead is waiting to turn or waiting for an approaching emergency vehicle, and is not in direct line of sight of the driver.

Traffic alerts within most GPS devices use information derived from radio data systems broadcasting information from a central source. Such systems include Radio Data System-Traffic Message Channel (RDS-TMC) which broadcasts traffic information as a subcarrier on FM broadcast signals, General Packet Radio Service (GPRS), or as signals over satellite radio services such as XM™ or Sirius™.

The Radio Data System (RDS) uses FM subcarrier technology and is sent as an additional signal transmitted along with the regular broadcasts from nearby FM stations. The traffic information sent by RDS uses information regarding traffic from the Department of Transportation or from an aggregator or network of traffic related information.

GPRS allows mobile networks to transmit IP packets to external networks such as the Internet. GPRS can also be used to transmit information regarding traffic from the Department of Transportation or from an aggregator or network of traffic related information.

Satellite radio can also transmit information regarding traffic from the Department of Transportation of from an aggregator or network of traffic related information.

These existing traffic reporting systems do not report data directly from individual sources to the GPS units in individual cars. Rather, the traffic information is reported to the vehicle over one of these radio systems from a centralized source of traffic information, and may not be available in non-metropolitan areas or local intersections within an area.

### SUMMARY

According to one embodiment of the present invention a method for determining an optimal lane recommendation of a road having a plurality of lanes for a primary vehicle within an optimal guided route to a destination. The method comprising: retrieving local environment data comprising real-time spatial data directly from at least one local source, the at least one local source comprising at least one sensor in an other vehicle; determining an optimal recommended lane of the road from the plurality of lanes of the road to minimize travel time for the primary vehicle, based on the directly retrieved environment data from the at least one source within a specific distance from the primary vehicle; and displaying the optimal recommended lane of the road for travel of the primary vehicle within the optimal guided route to the destination through an interface to a user.

According to another embodiment of the present invention, a computer program product for determining an optimal lane recommendation of a road having a plurality of lanes for a primary vehicle within an optimal guided route to a destination. The computer program product comprising: one or more computer-readable, tangible storage devices; program instructions, stored on at least one of the one or more storage devices, to retrieve local environment data comprising real-time spatial data directly from at least one local source, the at least one local source comprising at least one sensor in an other vehicle; program instructions, stored on at least one of the one or more storage devices, to determine an optimal recommended lane of the road from the plurality of lanes of the road to minimize travel time for the primary vehicle, based on the directly retrieved environment data from the at least one source within a specific distance from the primary vehicle; and program instructions, stored on at least one of the one or more storage devices, to display the optimal recommended lane of the road for travel of the primary vehicle within the optimal guided route to the destination through an interface to a user.

According to another embodiment of the present invention, a system for determining an optimal lane recommendation of a road having a plurality of lanes for a primary vehicle within an optimal guided route to a destination. The system comprising: one or more processors, one or more computer-readable memories and one or more computer-readable, tangible storage devices; program instructions, stored on at least one of the one or more storage devices for execution by at least one of the one or more processors via at least one of the one or more memories, to retrieve local environment data comprising real-time spatial data directly from at least one local source, the at least one local source comprising at least one sensor in an other vehicle; program instructions, stored on at least one of the one or more storage devices for execution by at least one of the one or more processors via at least one of the one or more memories, to determine an optimal recommended lane of the road from the plurality of lanes of the road to minimize travel time for the primary vehicle, based on the directly retrieved environment data from the at least one source within a specific distance from the primary vehicle; and program instructions, stored on at least one of the one or more storage devices for execution by at least one of the one or more processors via at least one of the one or more memories, to display the optimal recommended lane of the road for travel of the primary vehicle within the optimal guided route to the destination through an interface to a user.

### BRIEF DESCRIPTION OF THE SEVERAL VIEWS OF THE DRAWINGS

FIG. 1 depicts an exemplary diagram of a possible data processing environment in which illustrative embodiments may be implemented.

FIG. 2 shows a flowchart of a method of lane determination based on spatial data received directly from local sources along an optimal route to a destination.

FIG. 3 shows an example of lane determination based on spatial data received directly from local sources along an optimal route to a destination.

FIG. 4 shows an example of an interface of a guided destination device recommended an optimal lane.

FIG. 5 illustrates internal and external components of a client computer and a server computer in which illustrative embodiments may be implemented.

### DETAILED DESCRIPTION

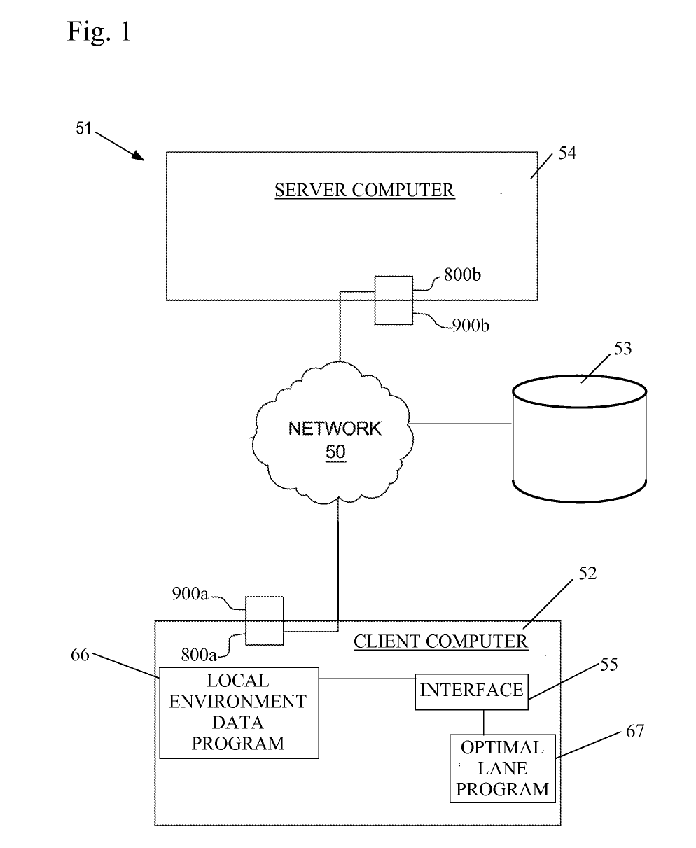

FIG. 1 is an exemplary diagram of a possible data processing environment provided in which illustrative embodiments may be implemented. It should be appreciated that FIG. 1 is only exemplary and is not intended to assert or imply any limitation with regard to the environments in which different embodiments may be implemented. Many modifications to the depicted environments may be made.

Referring to FIG. 1, network data processing system 51 is a network of computers in which illustrative embodiments may be implemented. Network data processing system 51 contains network 50, which is the medium used to provide communication links between various devices and computers connected together within network data processing system 51. Network 50 may include connections, such as wire, wireless communication links, or fiber optic cables.

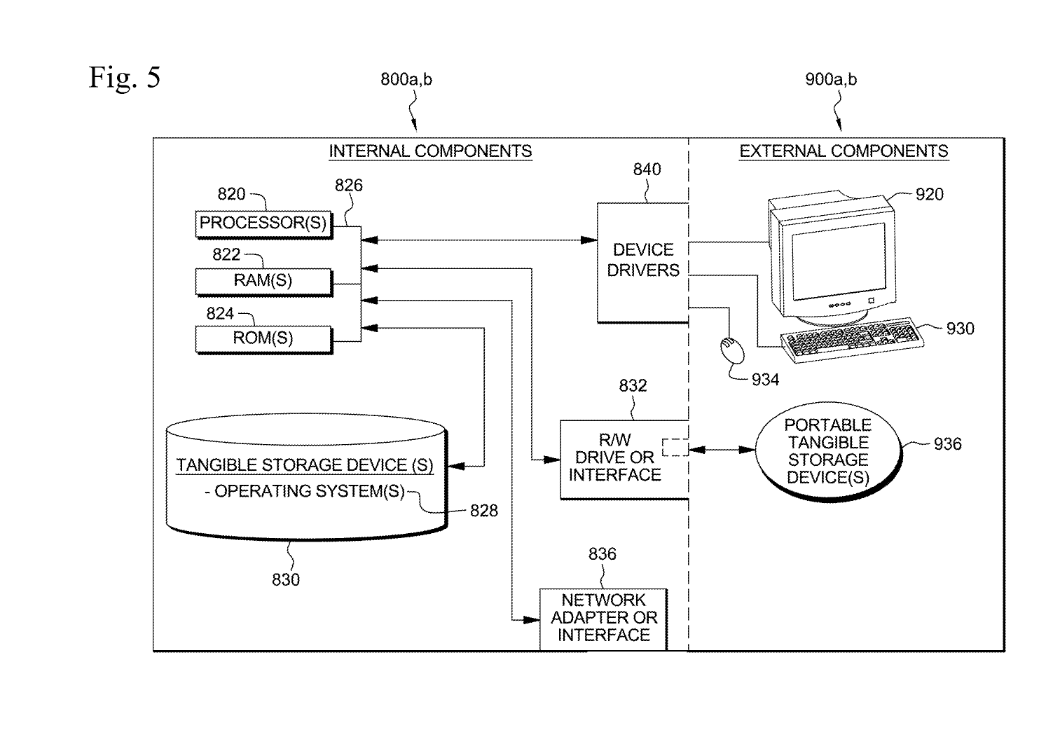

In the depicted example, a client computer 52, server computer 54, and a repository 53 connect to network 50. In other exemplary embodiments, network data processing system 51 may include additional client computers, storage devices, server computers, and other devices not shown. The client computer 52 includes a set of internal components 800a and a set of external components 900a, further illustrated in FIG. 5. The client computer 52 may be, for example, a mobile device, a cell phone, a personal digital assistant, a netbook, a laptop computer, a tablet computer, a desktop computer, a global positioning system (GPS) device, guided destination device, or any other type of computing device.

Client computer 52 may contain an interface 55. The interface can be, for example, a command line interface, a graphical user interface (GUI), or a web user interface (WUI). The interface may be used, for example for viewing instructions on how to get to the destination, maps of the area in which the user is in, and optimum lane within an optimal route to the destination. The interface may also accept an input regarding a destination in which the user wishes to reach, or settings as to how to calculate the optimal route to the destination.

In the depicted example, server computer 54 provides information, such as boot files, operating system images, and applications to client computer 52. Server computer 54 can compute the information locally or extract the information from other computers on network 50. Server computer 54 includes a set of internal components 800b and a set of external components 900b illustrated in FIG. 5.

Program code and programs such as an optimal lane program 67, and a local environment data program 66 may be stored on at least one of one or more computer-readable tangible storage devices 830 shown in FIG. 5, on at least one of one or more portable computer-readable tangible storage devices 936 as shown in FIG. 5, or repository 53 connected to network 50, or downloaded to a data processing system or other device for use. For example, program code, an optimal lane program 67, and a local environment data program 66 may be stored on at least one of one or more tangible storage devices 830 on server computer 54 and downloaded to client computer 52 over network 50 for use on client computer 52. Alternatively, server computer 54 can be a web server, and the program code, an optimal lane program 67, and a local environment data program 66 may be stored on at least one of the one or more tangible storage devices 830 on server computer 54 and accessed on client computer 52. Optimal lane program 67 and local environment data program 66 can be accessed on client computer 52 through interface 55. In other exemplary embodiments, the program code and programs such as an optimal lane program 67, and a local environment data program 66 may be stored on at least one of one or more computer-readable tangible storage devices 830 on client computer 52 or distributed between two or more servers.

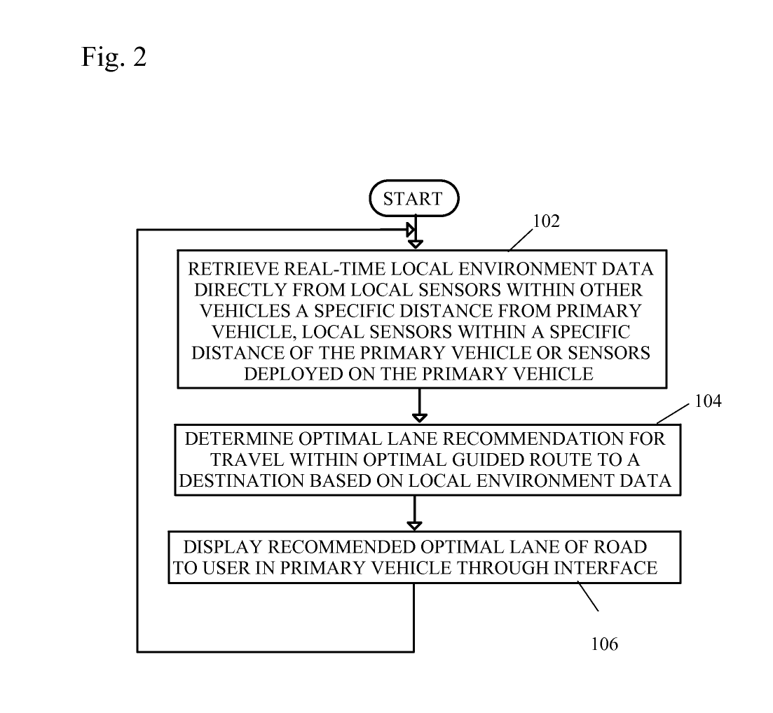

FIG. 2 shows a flowchart of a method of lane determination based on spatial data received directly from local sources along an optimal route to a destination. The method of FIG. 2 may be integrated into an application system which operates within a GPS device or other guided destination device 52 on an installed base of data to provide optimal lane recommendations based on algorithmic calculations.

The client computer 52, for example a GPS device or other guided destination device or program in a primary vehicle, retrieves local environment data (for example data on traffic conditions) directly from local sources including local sensors (step 102), for example through the local environment data program 66. The local environment data is not retrieved from a centralized source of traffic data on the area, or from a satellite signal or FM broadcast coupled to a centralized traffic database.

The local environment data provides spatial data around the primary vehicle locally within a small area directly from the local sources.

The local sources preferably include local environment data from other vehicles within a specific distance along the road on which the primary vehicle is traveling or from fixed sensors within a specific distance from the primary vehicle, or even from devices deployed on the primary vehicle itself in real-time.

The local environment data from other vehicles on the road within a specific range may be from vehicles connected to a vehicular ad hoc network (VANET). A vehicular ad hoc network (VANET) is a network of moving cars, each with a transceiver, that together create a mobile network. Each participating car within the network acts as a wireless router or node, allowing cars approximately up to 1000 feet of each other to connect and, in turn, create a network. As cars fall out of the signal range, they are removed from the network. Environment data from VANET would include data regarding motion of the vehicle relative to the lane being traveled in. The vehicles may include emergency response vehicles, such as ambulances, police cars, or fire trucks or non-emergency response vehicles, such as civilian vehicles.

The local environment data from fixed sensors, preferably stationary sensors relative to the road on which the primary vehicle is traveling, may include data from traffic cameras at street junctions, street signage, digital road signs, road sensors. The sensors provide accurate data regarding the number of cars waiting in specific lanes of the road.

This data may also include information reported from vehicles which are temporarily stopped in a fixed location, such as those which are incapacitated or emergency, construction or repair vehicles stopped on the road surface.

The devices deployed on the primary vehicle itself may be overhead cameras, for example those used in driverless cars. The cameras could provide video or pictures as to the number of cars waiting or present in each of the lanes of the road.

The specific distance in which the local environment data is collected is preferably a distance which is further than the driver's view and may be varied based on the size and congestion of the local area. The specific distance may be up to 1000 feet, for example. Furthermore, the specific range can also be set by the user of the guided destination device 52 in the primary vehicle through the interface 55.

The sources in which local environment data is collected by the local environment data program 66 may also be specified by the user through the interface 55. However, the more local sources of environment data which are used, the more accurate the optimal lane recommendation will be. In one embodiment, environment data is collected from at least two local sources, for example local sensors stationary relative to the road and from at least one secondary vehicle within a specific distance from the primary vehicle on the road.

The retrieval of local environment data of step 102 may be continuous, or may be initiated by reception of a traffic alert from a central server, reception of data from a local source, or by changes in motion of the primary vehicle containing the guided destination device 52.

It should be noted that the local environment data retrieved from the local sources is highly transitive, in that information regarding current traffic situations or approaching emergency vehicles is not likely to be relevant in the future and is not stored in a database of information to be integrated into future route calculations by the guided destination device 52.

An optimal lane recommendation for travel on the road within an already designated optimal guided route to a destination is determined based on the local environment data (step 104), for example by the optimal lane program 67. Therefore, the optimal lane program 67 considers local environment data such as stationary vehicles waiting to turn at street junctions, traffic signals at street junctions, route information from other vehicles, emergency vehicles, accidents, etc. . . .

The optimal lane recommendation may differ depending on the predetermined preferences of the driver, the algorithm used by the guided destination device, or the system itself. The optimal lane recommendation may be characterized as the shortest time to the destination, the least number of lane changes, the safest lane choice, or some other preference. For example, if there is construction ahead in a left lane, based on the predetermined preferences of the driver, the optimal lane may be to stay in the right lane to avoid lane changes, or stay as far from the accident as possible, or the optimal lane may be the left lane, where the driver can stay in the left lane as long as possible and merge when finally forced to do so since it is moving faster than the right lane.

The optimal lane recommendation for travel is displayed to a user within the vehicle through the interface 55 of the guided destination device 52 (step 106), for example through the optimal lane program 67.

After the optimal lane recommendation has been displayed, the method returns to step 102 of retrieving local environment data from local sources.

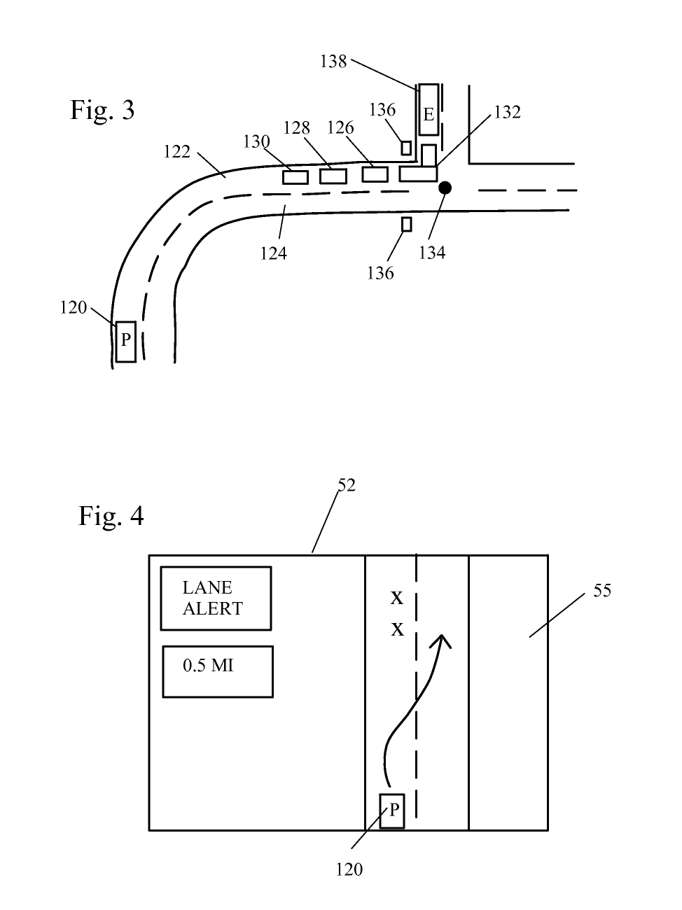

For example, referring to FIGS. 3 and 4, if a primary vehicle 120 is traveling on a road with two eastward bound lanes, a left lane 122 and a right lane 124, and local environment data retrieved includes local data from a local other vehicles 126, 128, 130 for example a vehicle 126 with a VANET broadcasting data regarding the amount of time the vehicle has been waiting within the left lane 122. Additionally, the primary vehicle 120 may retrieve environment data from a traffic camera 134 which shows several cars 126, 128, 130 waiting at an upcoming intersection in the left lane 122. Additional environment data may be retrieved from an emergency broadcast from a local emergency vehicle 138 within the specific distance of the primary vehicle 120 regarding an accident 132 in the left eastward bound lane. Local environment data may also be provided from signs 136 along the road. This information regarding the local congestion is provided directly from local sources to the primary vehicle 120 within the specific range of the primary vehicle 120. The optimal lane program 67 would determine that within the optimal guided route to the destination, the optimal recommended lane of travel to the destination is the right eastward bound lane and would display this recommendation to the user in the primary vehicle as shown in FIG. 4. The distance to the congestion may also be displayed through the interface of the guided destination device 52.

By using local environment data directly from local sources in combination with data regarding the guided route to a destination from a guided destination device 52, local spatial data around the vehicle is utilized, decreasing the time a user's vehicle would spend waiting in a congested or slowly moving lane, easing traffic congestion at intersections, even if the guided destination device 52 is not actively utilizing traffic guidance.

It should also be noted that the “local congestion” or “traffic” in which the optimal lane recommendation involves would be intended to detect localized backups, for example those involving less than 20 vehicles, rather than the wide-scale traffic delays and backups which are reported by existing systems.

FIG. 5 illustrates internal and external components of client computer 52 and server computer 54 in which illustrative embodiments may be implemented. In FIG. 5, client computer 52 and server computer 54 include respective sets of internal components 800a, 800b, and external components 900a, 900b. Each of the sets of internal components 800a, 800b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828, an optimal lane program 67, and a local environment data program 66 are stored on one or more of the computer-readable tangible storage devices 830 for execution by one or more of the processors 820 via one or more of the RAMs 822 (which typically include cache memory). In the embodiment illustrated in FIG. 5, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, 800b also includes a R/W drive or interface 832 to read from and write to one or more portable computer-readable tangible storage devices 936 such as a CD-ROM, DVD, memory stick, magnetic tape, magnetic disk, optical disk or semiconductor storage device. An optimal lane program 67, and a local environment data program 66 can be stored on one or more of the portable computer-readable tangible storage devices 936, read via R/W drive or interface 832 and loaded into hard drive 830.

Each set of internal components 800a, 800b also includes a network adapter or interface 836 such as a TCP/IP adapter card. Optimal lane program 67, and local environment data program 66 can be downloaded to client computer 52 and server computer 54 from an external computer via a network (for example, the Internet, a local area network or other, wide area network) and network adapter or interface 836. From the network adapter or interface 836, an optimal lane program 67, and a local environment data program 66 are loaded into hard drive 830. The network may comprise copper wires, optical fibers, wireless transmission, routers, firewalls, switches, gateway computers and/or edge servers.

Each of the sets of external components 900a, 900b includes a computer display monitor 920, a keyboard 930, and a computer mouse 934. Each of the sets of internal components 800a, 800b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

Optimal lane program 67, and local environment data program 66 can be written in various programming languages including low-level, high-level, object-oriented or non object-oriented languages. Alternatively, the functions of an optimal lane program 67, and a local environment data program 66 can be implemented in whole or in part by computer circuits and other hardware (not shown).

Based on the foregoing, a computer system, method and program product have been disclosed to determine an optimal lane recommendation of a road having a plurality of lanes for a primary vehicle within an optimal guided route to a destination. However, numerous modifications and substitutions can be made without deviating from the scope of the present invention. Therefore, the present invention has been disclosed by way of example and not limitation.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for determining an optimal lane recommendation of a road having a plurality of lanes for a primary vehicle within an optimal guided route to a destination, the method comprising:
retrieving local environment data comprising real-time spatial data directly from at least one local source, the at least one local source comprising at least one sensor in an other vehicle;
determining an optimal recommended lane of the road from the plurality of lanes of the road to minimize travel time for the primary vehicle, based on the directly retrieved environment data from the at least one source within a specific distance from the primary vehicle; and
displaying the optimal recommended lane of the road for travel of the primary vehicle within the optimal guided route to the destination through an interface to a user.

2. The method of claim 1, wherein the other vehicle is an emergency response vehicle.

3. The method of claim 1, in which the at least one local source further comprises at least one sensor in a fixed location relative to the road.

4. The method of claim 3, wherein the at least one sensor in a fixed location relative to the road are within traffic cameras.

5. The method of claim 3, wherein the at least one sensor in a fixed location relative to the road are within road signs.

6. The method of claim 1, wherein the at least one local source further comprises cameras deployed on the primary vehicle.

7. The method of claim 1, wherein the other vehicle is a vehicle within a vehicular ad hoc network and the local environment data is derived from information on the vehicular ad hoc network.

8. The method of claim 1, wherein the specific distance from the primary vehicle on the road is chosen such that the optimum recommended lane is displayed at a distance greater than the user's view of the road from the primary vehicle.

9. A computer program product for determining an optimal lane recommendation of a road having a plurality of lanes for a primary vehicle within an optimal guided route to a destination, the computer program product comprising:
one or more computer-readable, tangible storage devices;
program instructions, stored on at least one of the one or more storage devices, to retrieve local environment data comprising real-time spatial data directly from at least one local source, the at least one local source comprising at least one sensor in an other vehicle;
program instructions, stored on at least one of the one or more storage devices, to determine an optimal recommended lane of the road from the plurality of lanes of the road to minimize travel time for the primary vehicle, based on the directly retrieved environment data from the at least one source within a specific distance from the primary vehicle; and
program instructions, stored on at least one of the one or more storage devices, to display the optimal recommended lane of the road for travel of the primary vehicle within the optimal guided route to the destination through an interface to a user.

10. The computer program product of claim 9, wherein the other vehicle is an emergency response vehicle.

11. The computer program product of claim 9, in which the at least one local source further comprises at least one sensor in a fixed location relative to the road.

12. The computer program product of claim 11, wherein the at least one sensor in a fixed location relative to the road are within traffic cameras.

13. The computer program product of claim 11, wherein the at least one sensor in a fixed location relative to the road are within road signs.

14. The computer program product of claim 9, wherein the at least one local source further comprises cameras deployed on the primary vehicle.

15. The computer program product of claim 9, wherein the other vehicle is a vehicle within a vehicular ad hoc network and the local environment data is derived from information on the vehicular ad hoc network.

16. A system for determining an optimal lane recommendation of a road having a plurality of lanes for a primary vehicle within an optimal guided route to a destination, the system comprising:
one or more processors, one or more computer-readable memories and one or more computer-readable, tangible storage devices;
program instructions, stored on at least one of the one or more storage devices for execution by at least one of the one or more processors via at least one of the one or more memories, to retrieve local environment data comprising real-time spatial data directly from at least one local source, the at least one local source comprising at least one sensor in an other vehicle;
program instructions, stored on at least one of the one or more storage devices for execution by at least one of the one or more processors via at least one of the one or more memories, to determine an optimal recommended lane of the road from the plurality of lanes of the road to minimize travel time for the primary vehicle, based on the directly retrieved environment data from the at least one source within a specific distance from the primary vehicle; and
program instructions, stored on at least one of the one or more storage devices for execution by at least one of the one or more processors via at least one of the one or more memories, to display the optimal recommended lane of the road for travel of the primary vehicle within the optimal guided route to the destination through an interface to a user.

17. The system of claim 16, wherein the other vehicle is an emergency response vehicle.

18. The system of claim 16, in which the at least one local source further comprises at least one sensor in a fixed location relative to the road.

19. The system of claim 18, wherein the at least one sensor in a fixed location relative to the road are within traffic cameras.

20. The system of claim 18, wherein the at least one sensor in a fixed location relative to the road are within road signs.

21. The system of claim 16, wherein the at least one local source further comprises cameras deployed on the primary vehicle.

22. The system of claim 16, wherein the other vehicle is a vehicle within a vehicular ad hoc network and the local environment data is derived from information on the vehicular ad hoc network.
